(19) United States
(12) Patent Application Publication
(10) Pub. No.: US 2005/0133670 A1
(43) Pub. Date: Jun. 23, 2005

(54) Unified sensor-based attitude determination and control for spacecraft operations

(76) Inventors: H. Grant Wang, Hacienda Heights, CA (US); Rongsheng Li, Hacienda Heights, CA (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/727,764

(22) Filed: Dec. 3, 2003

(51) Int. Cl. B64G 1/38

(52) U.S. Cl. 244/170

(57) ABSTRACT

Systems and method of attitude determination and control for spacecraft include the use of a unified set of sensors for all phases of space flight. For example, the same set of sensors may be used for on-station operations and transfer orbit operations. The use of a unified set of sensors reduces complexity, spacecraft cost, and spacecraft weight.

### BACKGROUND OF THE INVENTION

1. Field of the Invention

This invention is generally directed to satellite attitude determination and control systems and methods, and, more particularly, to satellite attitude determination and control systems and methods that are applicable to both transfer orbit and on-station operations.

2. Description of the Related Art

Transporting a spacecraft from the ground to a destination orbit is an integral and crucial part of any spacecraft mission. For example, to insert a spacecraft into a geosynchronous orbit, a launch vehicle typically injects the spacecraft into a low-altitude parking orbit. The spacecraft then performs transfer orbit operations to transfer the spacecraft from the parking orbit to a destination orbit. The transfer orbit is usually performed by firing a liquid apogee motor (LAM) with the spacecraft spinning around a LAM axis to stabilize the spacecraft and to even the thermal and power conditions, or by firing a combination of LAM and XIP thrusters. Once the spacecraft has completed its transfer orbit, it then may enter in-orbit testing and on-station operation.

From cradle to grave, the spacecraft may go through the following phases of operations: separation, transfer orbit operation (including coasting, spin speed change, reorientation and LAM burn), deployment (including antennas, reflectors, solar wings, radiators), acquisition (including power acquisition and attitude acquisition), in-orbit test (including antenna mapping), on-station operation (including normal pointing, momentum dumping, station keeping and station change), and a deorbiting operation.

Typically, spacecraft, such as communication satellites, use multiple separate sets of sensors and control algorithms for different phases of spaceflight. For example, different sets of sensors and/or control algorithms may be used for attitude determination and control for bi-propellant spinning transfer orbit operations versus those that are used for on-station operations. The use of different sensors, attitude determination, and attitude control methods for spinning transfer orbits and on-station operations, respectively, increases the spacecraft weight, sensor and processor complexity, as well as the development cost for spacecraft attitude determination and control systems.

Spinning transfer orbit operations for spacecraft typically may be performed by ground-assisted attitude determination using a spinning earth sensor and a spinning sun sensor set. The measured leading edge and trailing edge of the earth detected by the earth sensor and the measured TOA (time of arrival) of the sun detected by the sun sensor collected and relayed periodically to a ground station. Typically, at least one orbit pass is dedicated this data collection. A ground orbital operator may then run a ground attitude determination algorithm using these inputs and ephemeris-computed sun and earth positions to determine the spin axis attitude of the spacecraft. This spin axis attitude (the spin phase being still undetermined) is then uploaded to the spacecraft. Next, on-board software may use this spin axis attitude together with the spin phase measured by the spinning sun sensor to complete the 3-axis attitude determination for subsequent spacecraft reorientation or liquid apogee motor (LAM) burn.

On-station spacecraft operations typically use different sensors, such as a staring earth sensor assembly (STESA) and a wide field of view (WFOV) sun sensor assembly (SSA), and/or a star tracker for attitude determination. Thus, the sensors used for transfer orbit operations may lie dormant for the entire time that the spacecraft is on station. The number of sensor types used and the number of sensors used, increase the hardware and development cost, increase weight and launch cost, and complicate the mission operation. In addition, some spacecraft have configurations and equipment that may make it difficult in some situations to provide a clear field of view for some sensors, such as, for example, a WFOV SSA, which spans a diamond of about 120×120 deg.

In addition, a wheel-gyro wobble and nutation controller (WGWANC) is typically used for spinning transfer orbit coasting control. A WGWANC can compensate for wobble, capture nutation, and alter spacecraft dynamics by counter-spin or super-spin. However, a WGWNC is very different from the 3-axis stabilized controller typically used for on-station operation. A WGWANC is also susceptible to interact with the fuel slosh dynamics introduced by spacecraft spinning. Fuel slosh is inherently very difficult to model and adds large uncertainty to the WGWANC stability margin. Thus, multiple control types are typically needed for spinning transfer orbit operations versus on-station operations. The use of multiple control types increases the design/analysis/simulation/software/test and other development costs.

The present invention is directed to overcoming one or more of the problems or disadvantages associated with the prior art.

### SUMMARY OF THE INVENTION

In accordance with one aspect of the invention, an attitude control system (ACS) and method uses a unified attitude sensor set, and may use identical 3-axis stabilized attitude determination and control methods for both spinning transfer orbit and on-station operations.

In accordance with another aspect of the invention, a modular ACS sensor architecture may be adapted to be used for both spinning transfer orbit and on-station operations.

According to an embodiment of the invention, an ACS includes unified 3-axis stabilized attitude determination and controls usable for both transfer orbit and on-station operations, a 3-axis stabilized controller for coasting, and a power/stellar acquisition sequencer, for recovering from an anomaly by reaching a power-safe state quickly.

### BRIEF DESCRIPTION OF THE DRAWINGS

Objects, features, and advantages of the present invention will be become apparent upon reading the following description in conjunction with the drawing figures, in which:

FIG. 1 is a diagram that illustrates various exemplary spacecraft orbits about the Earth;

FIGS. 2A-2C are side views of a spacecraft that may incorporate the invention;

FIG. 3 is a diagram that illustrates an example of a modular attitude control system architecture;

FIG. 4 is a flow diagram illustrating processing steps that may be used for attitude determination from star tracker data;

FIG. 5 is a block diagram illustrating an example of computer software units that may be used for transfer orbit and on-station attitude determination;

FIG. 6 is a block diagram illustrating further detail of an example of an attitude determination system that may be used for both transfer orbit and on-station operations;

FIG. 7 is a flow diagram illustrating an example of three-axis stabilized controller for coasting operations in a transfer orbit;

FIG. 8 is a block diagram further illustrating an example of a liquid apogee motor burn overturning torque feedforward control system and method;

FIG. 9 is a block diagram illustrating a power/stellar acquisition system and method for recovering a spacecraft in a power-safe fashion from an anomaly during a transfer orbit;

FIG. 10 is a diagram illustrating a spacecraft in a power safe state;

FIG. 11 is a diagram illustrating a spacecraft and designating regions in which the position of the sun relative to the spacecraft for either power safe or not power safe states;

FIG. 12 is a diagram illustrating a configuration in which a spacecraft is not in a power safe state; and

FIG. 13 is a graphic illustration of a synchronization of a spacecraft quaternion using solar panel current, in order to determine when a spacecraft is in a power-safe state.

### DETAILED DESCRIPTION

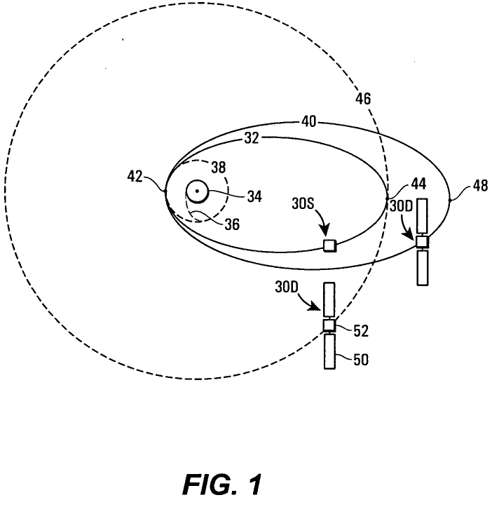

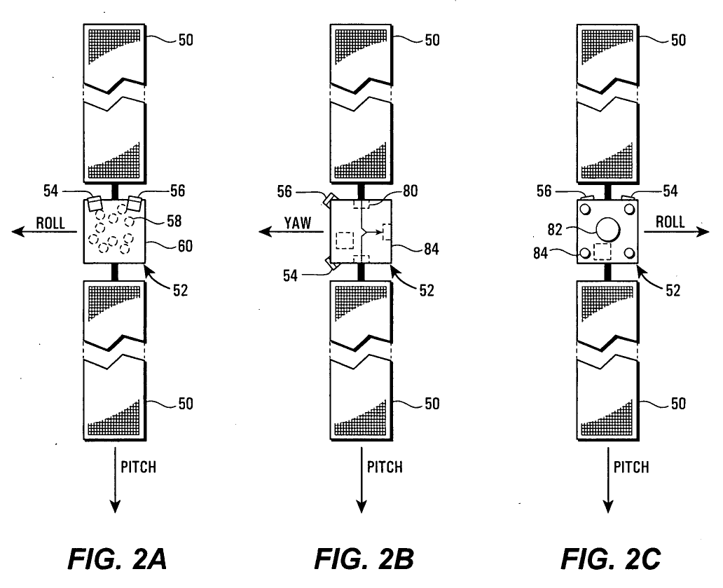

With reference initially to FIG. 1, a spacecraft 30S with its solar wings in a stowed position is depicted in a first transfer orbit 32 about the earth 34. Also depicted in FIG. 1 are a launch path 36, a parking orbit 38, and a second transfer orbit 40. The first transfer orbit 32, the parking orbit 38, and the second transfer orbit 40 may all have a common perigee point indicated at 42. The first transfer orbit 32 shares an apogee point indicated at 44, that is the same altitude as a geosynchronous orbit at 46. The second transfer orbit 40 has an apogee at 48 that is greater in altitude than the geosynchronous orbit 46. As indicated by the reference numeral 30D, the spacecraft in the second transfer orbit and in the geosynchronous orbit 46 may have solar wings 50 deployed and extending beyond a main portion 52 of the spacecraft 30D. As shown in FIGS. 2A-2C, the spacecraft 30D may include a primary star tracker 54 and a redundant star tracker 56, an optional gyro device, such as an inertial reference unit (IRU), and may carry any suitable payloads such as, for example, a set of communication antennas 58 that may be mounted on or near a positive yaw face 60 of the spacecraft 30D.

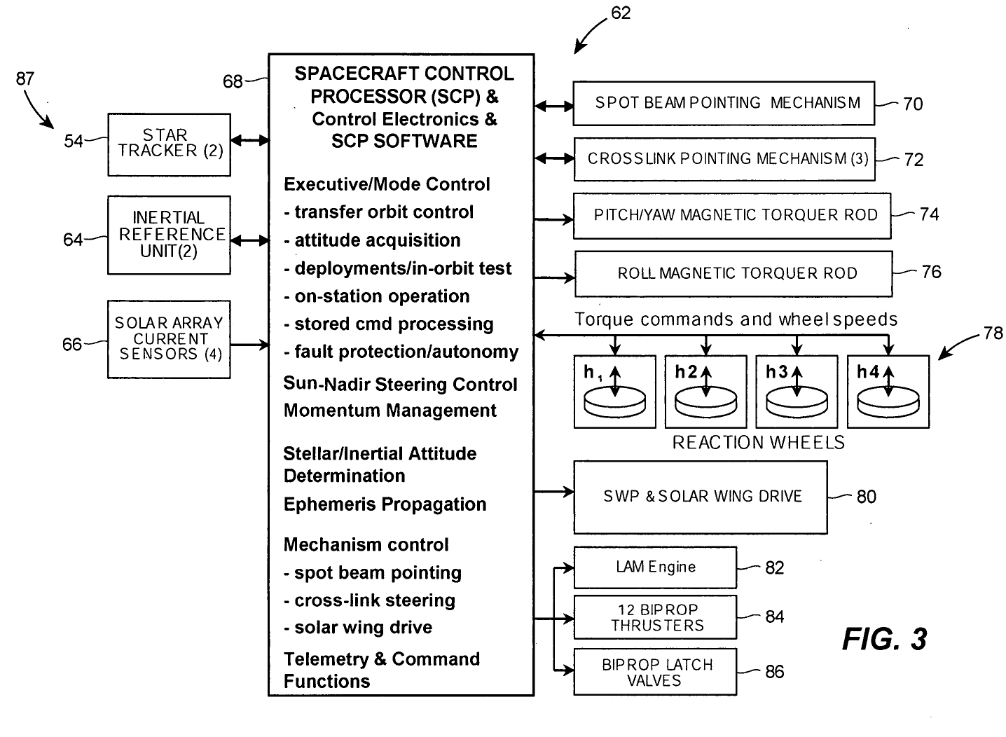

Now referring to FIG. 3, a spacecraft attitude control system architecture, generally indicated at 62, includes a star tracker 54, and may also include inertia measurement units 64, as well as solar array current sensors 66 that provide inputs to a spacecraft control processor 68. The spacecraft control processor 68 may be used to command many spacecraft systems such as, for example, a spot beam pointing mechanism 70, a crosslink pointing mechanism 72, a pitch/yaw magnetic torquer rod 74, a roll magnetic torquer rod 76, and a set of four or more reaction wheels 78 (that may be arranged in a pyramid configuration) by providing commands for wheel torque and/or wheel speed. In addition, the spacecraft control processor may provide commands to a solar wing positioner (SWP) and solar wing drive 80, as well as thrusters such as, for example, a liquid apogee motor engine 82, bipropellant thrusters 84, and bipropellant latch valves 86.

A unified attitude sensor set, generally indicated at 87, for multiple phases of spacecraft operations can be a plurality of star trackers 54. More than one star tracker 54 can be installed for failure redundancy and potential intrusion from bright objects, such as the sun, the moon and the earth. The star trackers are used to determine spacecraft attitude and derive spacecraft rate.

Alternatively, the unified attitude sensor set can be a plurality of star trackers 54 and inertia measurement units 64 (such as gyros) for multiple phases of spacecraft operations. The spacecraft attitude, rate and acceleration are determined by use of a Kalman filter using star tracker and gyro measurement data. Gyro parameters can also be calibrated by star tracker measurement in the Kalman filter. As a further alternative, the unified attitude sensor set can further be a plurality of star trackers, in addition to gyros and, or solar panel current sensors. Star tracker and gyro data may be used to determine spacecraft attitude, rate and acceleration, and calibrate gyro parameters via a Kalman filter. The solar panel current sensors may be used to validate the acquired stellar attitude after a loss-of-attitude anomaly, to position the wing-stowed spacecraft 30S for power safety, and to position the solar wing for power safety for wing-deployed spacecraft.

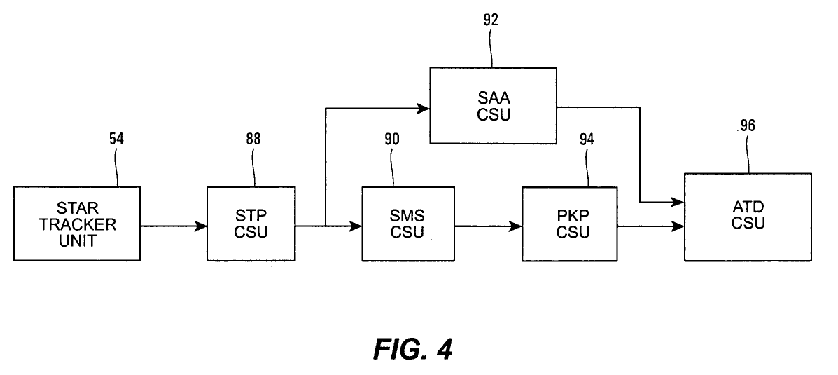

With reference to FIG. 4, a control software system may include computer software units (CSUs) such as star tracker processing (STP) CSU 88), that provides input to both a star measurement and steering (SMS) CSU 90 and a stellar attitude acquisition (SAA) CSU 92. The SMS CSU 90 provides input to a pre-kalman processor (PKP) CSU 94, and the SAA CSU 92 and the PKP CSU 94 both provide input to an attitude determination (ATD) CSU 96.

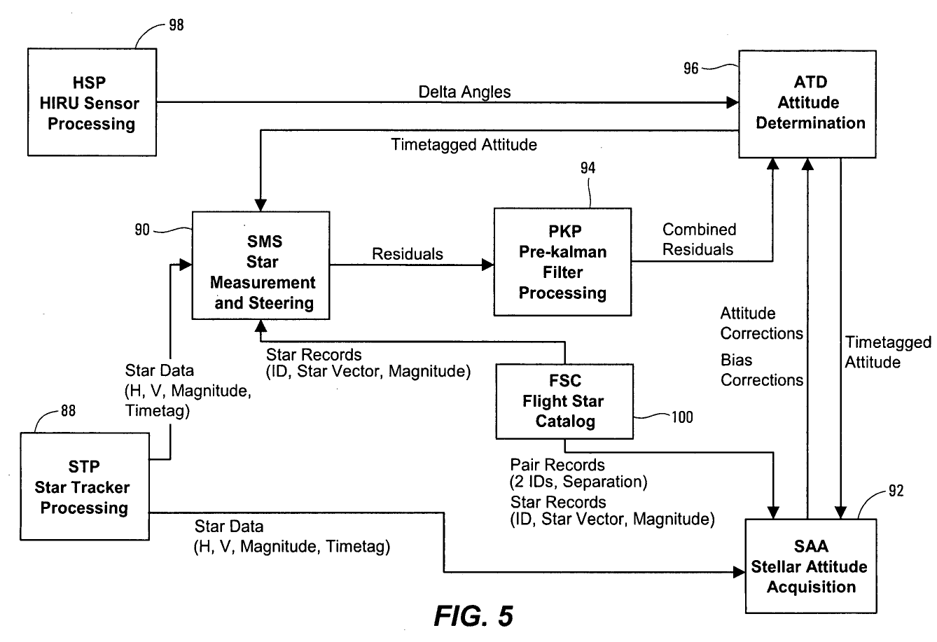

Now referring to FIG. 5, showing exemplary software units that may be used for transfer orbit and on-station attitude determination, a hemispherical inertial reference unit (HIRU) sensor processing CSU 98 operates in parallel with processing of data from the star tracker unit 54, in providing attitude data to the ATD CSU 96. In addition, a flight star catalog (FSC) CSU 100 provides data to the SMS CSU 90 and the SAA CSU 92. In a scenario in which the attitude is lost and needs to be initialized during both transfer orbit and on-station operations, the STP CSU 88 may provide input directly to the SAA CSU 92 for attitude acquisition and initialization, whereas during nominal transfer orbit and on-station operations, the data from the STP CSU 88 may be provided to the SMS CSU 90 which in turn provides residual data to the PKP CSU 94 for preprocessing and subsequent handoff to the ATD CSU 96. The unified sensor architecture and attitude determination/control method can also be used to perform other typical spacecraft operations, such as separation, deployment, station keeping, and deorbiting.

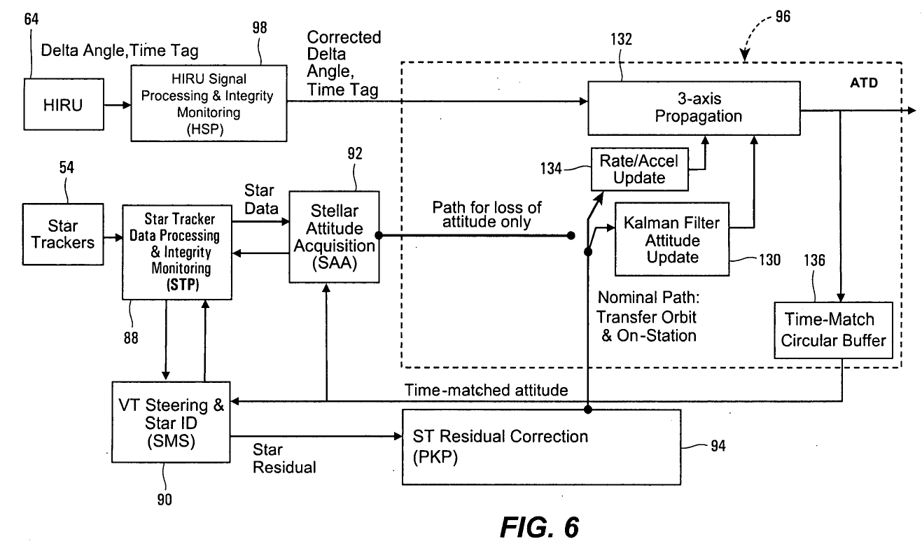

With reference to FIG. 6, the ATD CSU 96 is shown in further detail, to include a common filter attitude update CSU 130, a three axis propagation CSU 132, a rate/acceleration update CSU 134, and a time-match circular buffer CSU 136. As shown in FIG. 6, a separate path is used where there is a loss of attitude in which the stellar attitude acquisition CSU 92 provides inputs to the common filter attitude update CSU 130. On the other hand, for nominal transfer orbit operations and nominal on-station operations, the PKP CSU 94 provides input to the common filter attitude update CSU 130.

A WGWANC controller is typically not effective at slow spin rates. However, a 3-axis stabilized controller can perform WGWANC control function by making the momentum in ECI as the attitude steering target.

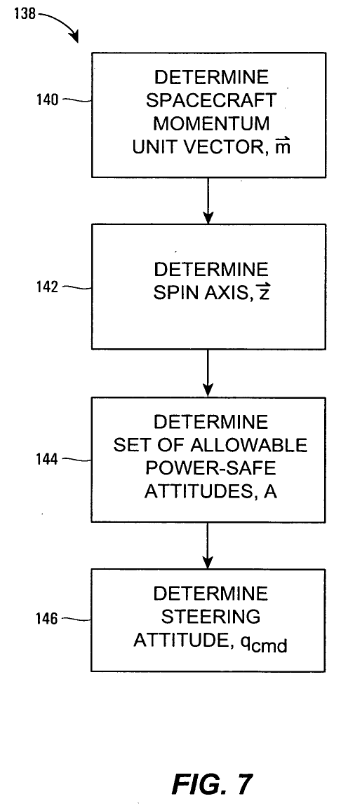

Now referring to FIG. 7, a flow diagram for providing three-axis stabilized control during a coasting operation in a bi-propellant transfer orbit is generally indicated at 138. At block 140, the spacecraft momentum unit vector, \vec{m}, is determined in earth centered inertial (ECI) coordinates. At block 142, the designated spacecraft spin axis \vec{z}, is determined, also in ECI coordinates. The designated spacecraft spin axis can be any axis in the spacecraft body, but is usually the z-axis or x-axis in a typical spacecraft mission. Next, at block 144, a set of allowable power safe attitudes is determined, for example, attitudes having a sun polar angle of 90±20 deg. Next, at block 146, a steering attitude, q_{cmd}, is determined by finding the attitude that has the spin axis aligned with the momentum vector in ECI coordinates, but within a power safety constraint of being within the set of allowable power safe attitudes, A:
q_{cmd}: min(<\vec{m},\vec{z}>)) such that q_{cmd}⊂A
where the <.,.> is a mathematical symbol for the inner product or dot product of two vectors.

If power safety can be maintained, the steering law by q_{cmd}: min(<\vec{m}, \vec{z}>) of the spacecraft 30S will have a steering attitude such that the designated spin axis is aligned with the momentum vector. The control law will command wheel momentum in a direction which is perpendicular to both the designated axis and the momentum vector (i.e., \vec{m}×\vec{z} direction) to bring the two vectors to be co-aligned. This is the 3-axis stabilized version of the existing GWANC control law.

Thus, the three-axis stabilized controller can perform WGWANC-like control functions in a slow-spin transfer orbit operation. The benefit of this steering law for the steering attitude is that it reduces the reaction wheel activities and power consumption. A derivative of this steering law is by maximizing the difference between the power received from solar panel and the power consumed by the reaction wheels 78.

During a bi-propellant transfer orbit, the spacecraft 30S may be deliberately spun at a low rate (e.g., 0.3 deg/sec), to remain within the Star Tracker Assembly (STA) sensor tracking rate limit (e.g., <3.0 deg/sec in sensor frame), and such that 3-axis stabilized controls can be used in lieu of the WGWNAC controllers. The nominal spin rate may be set at only one-tenth of the STA tracking rate limit so that it will remain below the STA tracking rate limit, even after an unexpected thruster failure that spins up the spacecraft. The 3-axis stabilized controller has the option to use the momentum vector in Earth-centered inertial (ECI) coordinates as the z-axis target, similar to WGWANC controllers.

The above steering law is merely an example, with more steering laws introduced below. The steering law can be derived by maximizing the reaction wheel momentum storage duration with steering attitude within the power safe attitude set. This will lead to placing the spin axis to where the environmental torque effect is a minimum and the reaction wheel pyramid has the maximum margin for momentum storage. The momentum accumulated due to environmental torques may be dumped whenever necessary in the subsequent reorientation or burn maneuvers. The steering attitude can be optimized to be closer to the next LAM burn attitude to reduce next reorientation time and fuel consumption for the next LAM burn. This steering law may be used to place the coasting attitude as close as is practical to the next burn attitude as possible. The steering attitude may be set to maximize the difference between the power received by the solar panel and the power consumed by heaters, or to minimize power received by solar panel minus power consumed by heaters minus power consumed by the reaction wheels 78). The steering attitude can also be an optimization of the combination of the aforementioned objectives. In general, the optimal steering attitude may not be fixed over time, and may be a time-varying attitude trajectory.

The LAM overturning torque during a LAM burn is fixed in the spacecraft body frame. The magnitude is proportional to the LAM force and the moment arm between LAM force and the center-of-mass. One potential drawback of slow spinning is higher LAM turn on/off transients due to reduced gyroscopic stiffness (although simulation indicates that the transient is lower at low spin rate due to small thruster firing phase lag). The transient is partially due to the time lag in the acceleration estimation. By reducing the time constant of the acceleration estimation loop, we can generally reduce the transients. Furthermore, by re-initializing the estimated acceleration to an a priori value, either based on pre-launch LAM alignment survey or based on previous burn acceleration estimate, the transient can be virtually subdued.

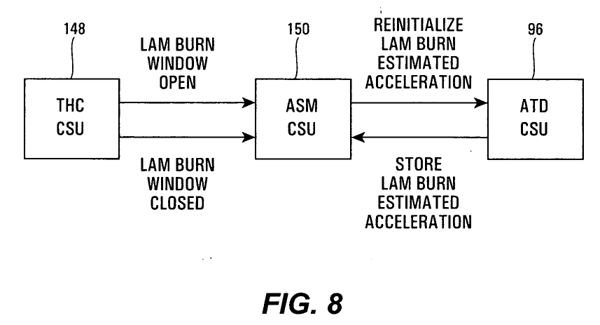

With reference to FIG. 8, a Thruster Controller (THC) computer software unit (CSU) 148 determines LAM burn window opening and closing times, and provides them to a LAM burn sequencer or ascending mode sequencer (ASM) CSU 150. The LAM burn may also use 3-axis stabilized control at a slow-spin rate, and may use thrusters and/or the reaction wheels 78 to make attitude corrections during the LAM burn. LAM burn on-off transients may be reduced by estimating the overturning torque, and then feeding-forward the overturning torque in the form of an acceleration estimate to the ATD CSU 96. This estimated acceleration due to the overturning torque can be stored in the ASM CSU 150, and may be used to re-initialize the acceleration at the start of burn, and to reset the acceleration to zero at the end of the burn. In addition, the spacecraft 30S may be reoriented prior to each coasting operation and prior to each LAM burn, for example, to maximize solar power during coasting, as noted above, and/or to minimize fuel needed for attitude control during each LAM burn.

The timing for the LAM burn estimated acceleration re-initialization is as follows:

Based on pre-launch survey of LAM orientation and estimated center-of-mass and spacecraft inertia, an a priori estimated acceleration of LAM overturning torque, a 3×1 vector in units of rad/sec/sec, is computed and stored in the ASM CSU 150.

When the LAM burn software window is open and the LAM is to fire, the ASM CSU 150, may reinitialize the estimated acceleration in ATD CSU 96 to the value stored in the ASM CSU 150 to immediately compensate for the LAM overturning torque to reduce the turn on transient.

When the LAM burn is about to end, the ASM CSU 150 may store the estimated acceleration from the ATD CSU 96 for use in the next LAM burn. Note that this end condition is very close to the initial condition for the next LAM burn.

When the LAM stops firing, the ASM CSU 150 may immediately reinitialize the estimated acceleration in the ATD CSU 96 to zero to reduce the LAM turn off transient.

A simultaneous power and stellar attitude acquisition sequencer may be provided for the bi-propellant spinning transfer orbit operation (when the solar wings 50 are stowed, using exposed solar panel currents). The sequencer may maintain a steady spin, and then configure and command the stellar attitude acquisition in parallel in the background processing. The sequencer may also synchronize a quaternion of the spacecraft 30S with the panel current such that, for example, the identity quaternion is synchronized with the panel peak current, and a quaternion with a spin phase of 90 degrees is synchronized with the zero panel current. Therefore, controlling the spacecraft to an identity quaternion may bring the sun to the plane of the spin axis and the exposed solar panels normal to the sun to provide maximum panel current for power safety.

To provide a power safe, 3-axis stellar attitude acquisition for the wing-deployed spacecraft 30D (solar wings 50 deployed, without the need of a sun sensor assembly (SSA)), a stellar attitude acquisition mode may simultaneously perform a slow rotisserie maneuver for power safety and use STA attitude acquisition to acquire the spacecraft attitude. When the wing is deployed, a simple rotisserie maneuver at an appropriate rate along any axis perpendicular to the wing-rotation-axis can maintain power/thermal safety indefinitely (momentum safety can also be assured provided a solar tacking algorithm is in place). For non-XIP spacecraft with the potential of high momentum due to faulty thruster stuck-on (an event classified as highly improbable in failure mode analysis), the reaction wheels 78 may be saturated if there are only 3 reaction wheels left, and a GWANC-like controller is needed. The GWANC-like controller may align the spacecraft momentum vector with the z-axis and reaction wheel momentum bias can be commanded in the same direction to reduce the spin rate to suit stellar attitude acquisition.

Various examples of procedures for power/attitude acquisition in bi-propellant phase for the wing-stowed spacecraft 30S (solar wing stowed, no SSA) will now be described:

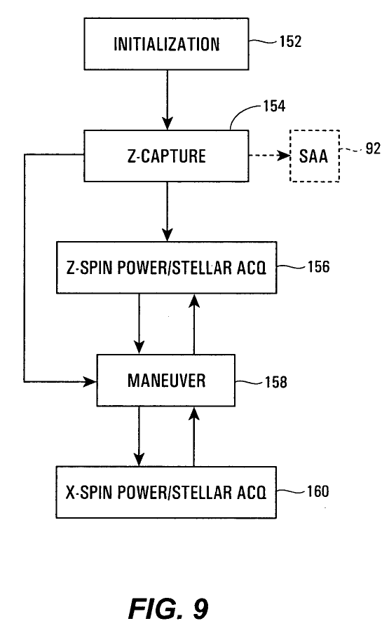

Wing current synced power acquisition: Owing to the slow spin, the momentum after a failure is within the reaction wheel momentum envelope. With reference to FIG. 9, after initialization at block 152, at block 154 the z-axis is captured using the SAA 92, and the spacecraft 30S may maneuver to a z-spin configuration, as indicated at block 158. The spacecraft 30S may then maintain a steady z-spin configuration as indicated at block 156, by rate control using the reaction wheels 78, use the wing current sensor to measure the peak current and to detect the spin phase when the peak current occurred. If the peak current is over the power-safe threshold, the spacecraft 30S is power safe and can remain in this state. If the peak current is low (e.g., sun to spin axis separation angle less than 70 deg), a maneuver may be performed (block 158) to bring the spacecraft 30S to a x-spin configuration, as indicated at block 160.

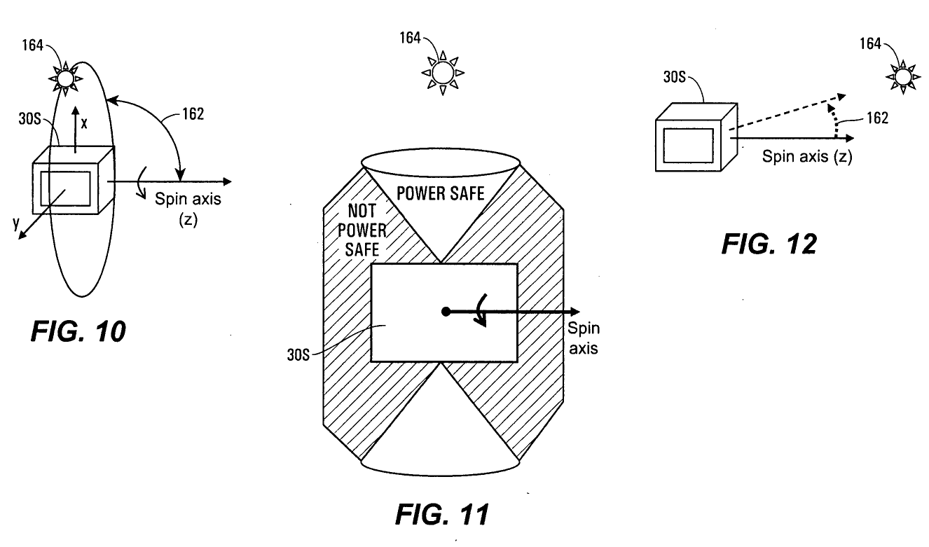

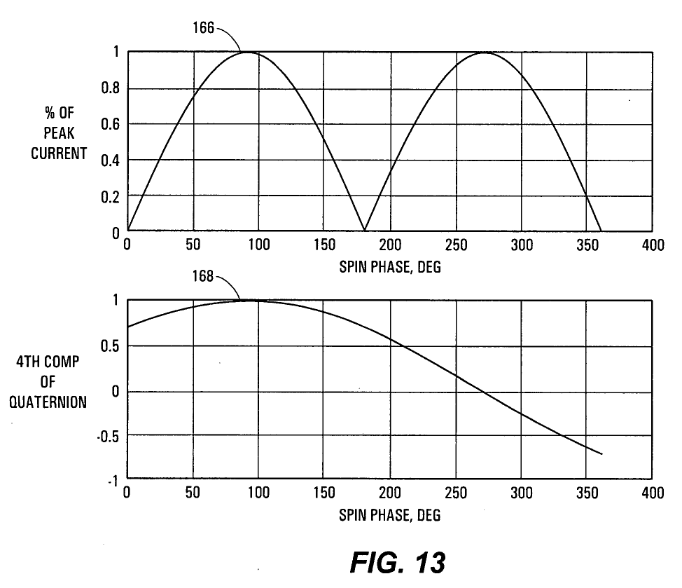

As indicated in FIG. 10, the sun polar angle 162 when the spacecraft 30S reaches the z-spin configuration will be 90±20 deg). As shown in the plots of FIG. 13, if the spacecraft is not power safe, the controller may detect peak current 66, memorize or reset the quatemion 168 at the peak current, and transition to x-spin. Stellar attitude acquisition may be performed in parallel with power acquisition. Examples of stellar attitude acquisition and control systems and methods may be found in U.S. Pat. No. 6,470,270, issued to Needelman et al. on Oct. 22, 2002, and U.S. Pat. No. 6,571,156, issued to Wang et al. on May 27, 2003, both of which are owned by the assignee of the present application, and both of which are hereby expressly incorporated by reference herein.

A wing current based, quatemion triggered, sun-spin-axis precession (reorientation) using a thruster may also be used for the spacecraft 30S to reach a power safe attitude. An appropriate algorithm may be used to process the spin axis either toward or away from the sun-line until power is maximized. The same 3-axis stellar attitude acquisition may be performed simultaneously to acquire the attitude.

In addition, one may run the attitude acquisition mode as above, using the reaction wheels 78 or a thruster to stop the spin or to spin at slow rate, and simultaneously command 3-axis stellar attitude acquisition to acquire the attitude. This may be accomplished by budgeting power margin (for example, GEM currently has 6 hours and typical BS702 spacecraft have 15 hours of battery life after a failure) to allow sufficient time for attitude acquisition (<0.5 hours), and then slewing to the desired power safe spin attitude, such as placing a spin axis in the ECI north/south direction.

Still further, one may use a binary halving method to find the maximum-power spin-axis in x/z plane using thrusters. This is a systematic trial and error method to find the spin axis in x/z plane that is perpendicular to the sun line at that instant.

Acquired stellar attitude monitored with wing current threshold can be performed as follows:

Let \vec{s}_{ECI} be the sun unit vector in the ECI frame, then \vec{s}_{B}=C_{ECI}^{B}\vec{s}_{ECI} is the sun unit vector in the body frame, where C_{ECI}^{B} is the attitude determined by the gyro and the star tracker.

Let \vec{u}ₙ and \vec{u}ₛ be the normal unit vectors for north and south solar panels, and let Imax be the panel current when the sun is perfectly normal to the panel, then, the predicted north panel current is Iₙ=Iₘₐₓ(\vec{u}ₙ·\vec{s}_{B}), and the predicted south panel current is Iₛ=Iₘₐₓ(\vec{u}ₛ·\vec{s}_{B}).

Let I_{measured} be the measured panel current from the Integrated Power Controllers (IPC), then the panel current residual is
I_{measured,n}−Iₙ
I_{measured,s}−Iₛ

The bi-propellant transfer orbit can be performed with no spin at all, using 3-axis stabilized controller. This will make the transfer orbit no different from on-station as far as attitude determination and control is concerned, and allow the spacecraft 30S to have a modular and unified ATD/ATC for both transfer orbit and on-station operations.

The invention provides a modular ACS sensor architecture for a “unified” attitude determination and control for spacecraft cradle-to-grave operations, with capability for on-board autonomous attitude determination and control during separation, transfer orbit, deployment, on-station, deorbiting and other operations. The invention may be incorporated into a spacecraft mission plan, either as a primary or contingent portion of the mission plan. Thus, insurance costs may be reduced by using the invention, since, for example, failure of a sensor ordinarily used during a spinning transfer orbit, will not be fatal to a spacecraft mission that includes the invention as a contingent portion of the mission plan.

The simplified modular ACS (Attitude Control System) sensor architecture may use a gyro-based inertial reference unit and star tracker assembly, GYRO+STA only, for all mission operations. Sensors such as Staring Thermostatic Earth Sensor Assemblies (STESA), Horizon Crossing Indicators (HCI), Sun Sensor Assemblies (SSA), transfer orbit Earth sensors (TOES), transfer orbit sun sensors (TOSS), Acquisition Sun Sensors (ACSS), Extended Transfer Orbit Sun Sensors (EXTOSS) are not needed and may be eliminated. In addition, the rates used for feedback control may be derived from star tracker measured star positions, and the gyros (e.g., HIRU) are therefore not needed either. The unified attitude determination may include a TRIAD method for attitude initialization/acquisition, and a linearized QUEST combining with a Kalman filtering for the on-station pointing. However, other attitude determination methods can be used. Using an identical attitude determination method for both transfer orbit operations and on-station operations to reduces hardware and development cost.

Although the preferred embodiments of the invention have been disclosed for illustrative purposes, those skilled in the art will appreciate that various modifications, additions and substitutions are possible, without departing from the scope and spirit of the invention as disclosed herein and in the accompanying claims.

1. An attitude determination and control system for a spacecraft comprising:
a unified attitude sensor set that is adapted for use during all phases of spacecraft operations; and
a processor capable of determining and controlling attitude of said spacecraft during said operations solely using sensor inputs from the unified attitude sensor set.

2. The attitude determination and control system of claim 1, wherein the unified attitude sensor set includes at least one star tracker.

3. The attitude determination and control system of claim 2, wherein star tracker data is used to determine spacecraft attitude for transfer orbit operations and on-station operations.

4. The attitude determination and control system of claim 2, wherein star tracker data is used at least in part to determine spacecraft rate.

5. The attitude determination and control system of claim 2, wherein star tracker data is used at least in part to determine spacecraft attitude.

6. The attitude determination and control system of claim 2, wherein the unified attitude sensor set further includes at least one inertial measurement unit.

7. The attitude determination and control system of claim 6, wherein the inertial measurement unit is a gyro device.

8. The attitude determination and control system of claim 7, wherein the gyro device is used at least in part to determine spacecraft rate.

9. The attitude determination and control system of claim 7, wherein the gyro device is used at least in part to determine the spacecraft attitude.

10. The attitude determination and control system of claim 7, wherein the star tracker data is used at least in part to determine the spacecraft attitude.

11. The attitude determination and control system of claim 7, wherein the attitude determination and control system uses the star tracker data to calibrate the gyro device.

12. The attitude determination and control system of claim 2, wherein the unified attitude sensor set further includes a solar panel current sensor.

13. The attitude determination and control system of claim 12, wherein the attitude determination and control system uses the solar panel current sensor is used at least in part to position the spacecraft body for power safety after loss-of-attitude.

14. The attitude determination and control system of claim 12, wherein the attitude determination control system uses the solar panel current sensor is at least in part to position the solar wing for power safety.

15. The attitude determination and control system of claim 12, wherein the attitude determination control system uses the solar panel current sensor to validate an acquired stellar attitude.

16. The attitude determination and control system of claim 1, wherein the spacecraft operations include transfer orbit operations and on-station operations.

17. The attitude determination and control system of claim 16, wherein the transfer orbit operations include a bi-propellant transfer orbit operation.

18. The attitude determination and control system of claim 16, wherein the transfer orbit operations include an electrical propulsion transfer orbit operation.

19. The attitude determination and control system of claim 18, wherein the electrical propulsion transfer orbit operation is performed using a XIP engine.

20. The attitude determination and control system of claim 18, wherein the electrical propulsion transfer orbit operation is performed using a Hall Effect Thruster.

21. The attitude determination and control system of claim 1, wherein the processor includes electronic hardware.

22. The attitude determination and control system of claim 1, wherein the processor includes software.

23. The attitude determination and control system of claim 1, wherein the spacecraft has its solar wings stowed.

24. The attitude determination and control system of claim 1, wherein the spacecraft has its solar wings deployed.

25. (canceled)

26. (canceled)

27. An attitude determination and control system for a spacecraft comprising:
a plurality of star trackers adapted for use during all phases of spacecraft operations; and
a processor capable of determining and controlling attitude of the spacecraft during the spacecraft operations using inputs from the star trackers as the sole source of attitude sensor data.

28. The attitude determination and control system of claim 27, wherein the spacecraft operations include transfer orbit operations and on-station operations.

29. An attitude determination and control system for a spacecraft comprising:
a plurality of star trackers and gyro units that are adapted for use during all phases of spacecraft operations; and
a processor capable of determining and controlling the attitude of the spacecraft during the spacecraft operations using inputs from the star trackers and gyros as the sole source of attitude sensor data.

30. The attitude determination and control system of claim 29, wherein the spacecraft operations include transfer orbit operations and on-station operations.

31. An attitude determination and control system for a spacecraft comprising:
a plurality of star trackers, gyro units and solar wing current sensors that are adapted for use during all phases of spacecraft operations; and
a processor capable of determining and controlling the attitude of the spacecraft during the spacecraft operations using inputs from the star trackers, gyro units and solar wing current sensors as the sole source of attitude sensor data.

32. The attitude determination and control system of claim 31, wherein the spacecraft operations include transfer orbit operations and on-station operations.

33. (canceled)

34. (canceled)
